(19) United States
(12) Patent Application Publication
(10) Pub. No.: US 2019/0078352 A1
(43) Pub. Date: Mar. 14, 2019

(54) TRIGGERED ROTATION- ARRESTING DEADBOLT

(71) Applicant: Rav Bariach (08) Industries Ltd, Ashkelon (IL)

(72) Inventors: Peter NICOARA, Ashdod (IL); Eran GOLDSTEIN, Givatayim (US)

(73) Assignee: Rav Bariach (08) Industries Ltd, Ashkelon (IL)

(21) Appl. No.: 16/124,064

(22) Filed: Sep. 6, 2018

Related U.S. Application Data
(60) Provisional application No. 62/556,594, filed on Sep. 11, 2017.

(51) Int. Cl. E05B 17/20; E05B 9/10; E05B 17/00; E05B 17/04; E05B 27/00

(52) U.S. Cl. CPC E05B 17/2092; E05B 9/105; E05B 27/0057; E05B 17/047; E05B 17/0062

(57) ABSTRACT

The disclosure relates in general to a locking mechanism for a door. Specifically, the disclosure relates to a thumbturn latching mechanism having a triggered rotation-arresting assembly therein, configured to inhibit rotation of the lock mechanism upon unauthorized removal of the posterior portion of the latching mechanism, while still allowing for selectably bypassing the rotation-arresting mechanism from the anterior portion of the locking mechanism.

### BACKGROUND

The present disclosure is directed in general to a locking mechanism for a door. Specifically, the disclosure is directed to a thumbturn latching mechanism having a triggered rotation arresting assembly therein, configured to inhibit rotation of the lock mechanism upon unauthorized removal of the posterior portion of the latching mechanism, while still allowing for selectably bypassing the rotation-arresting mechanism.

While in the past deadbolt locks have adequately secured doors and the like against unauthorized entry, they are continuously being subjected to unprecedented abuse and assault. Cylinder operated locks can be provided with ever-more sophisticated pick resistant cylinders, but picking the lock is not always the major problem to be guarded against. Rather, the lock mechanism, or more specifically deadbolts, can often be subject to a forced withdrawal of the exposed cylinder plug, resulting in the shearing of locking pins, thus effectively disabling the locking mechanism. This can typically be done by, for example, specialized tools, a screw driver or similar tools.

For example, U.S. Pat. No. 4,961,328 discloses a cylinder lock with a cylinder housing and, rotatably mounted therein, a cylinder plug comprising a key passage extending along its longitudinal axis, with a lock bit coupled to the cylinder plug and rotatably mounted in the cylinder housing, with a barrier element consisting of a locking pin displaceably mounted in a bore which extends in parallel with the longitudinal axis of the cylinder housing and which is open towards the lock bit, the locking pin being biased by a spring in the direction of the lock bit. Also included is a catch which, when the lock is intact, maintain the locking pin remote from the lock bit and which, when the cylinder plug forcibly extracted, release the locking pin and engages a recess in the lock bit or moves into the path of the lock bit. No bypassing mechanism is disclosed, which would require removal of the whole cylinder prior to reopening the latched door from the interior.

Alternatively, published international Application No. PCT/GB2009/001592, discloses a lock mechanism, with a lock cam actuable to unlock the lock mechanism. The assembly comprising a first lock actuator assembly positioned on a first side of the lock cam, a second lock actuator assembly positioned on a second side of the lock cam, the second side being substantially opposite the first side, a clutch defining an axis, the clutch being movable along the axis between: a first condition in which the clutch provides a rotational force path from the first actuator to the lock cam to lock or unlock the lock mechanism, a second condition in which the clutch provides a rotational force path from the second actuator to the lock cam to lock or unlock the lock mechanism, and a third condition in which the clutch is not movable along the axis, The assembly further comprising a security mechanism configured to put the clutch into the third condition upon removal of a component of the lock mechanism. Here too, a bypassing mechanism is not disclosed, which would require removal of the whole cylinder prior to reopening the latched door from the interior

These and other deficiencies in the prior art are addressed in the following disclosure.

### SUMMARY

Provided herein are embodiments of a latching mechanisms having a triggered rotation arresting assembly therein, configured to inhibit rotation of the lock mechanism upon unauthorized removal of a posterior portion of the latching mechanisms, while still allowing for selectably bypassing the rotation-arresting mechanism.

In an embodiment, provided herein is a cylinder lock having an anterior end and posterior end along a longitudinal axis, the lock comprising: an anterior lock actuator assembly positioned axially anterior to a lock cam; the lock cam, adapted to lock and/or unlock the lock mechanism; a posterior lock actuator assembly comprising a knob operably coupled to a shaft positioned axially posterior to the lock cam; a clutch assembly, the clutch assembly being movable along the longitudinal axis between: a first position configured to transfer a rotational force path from the anterior lock actuator assembly to the lock cam; a second position configured to transfer a rotational force path from the posterior lock actuator assembly to the lock cam; and a third position in which the clutch is not movable along the axis, the third position triggered automatically upon removal of an anterior component of the cylinder lock, wherein the posterior lock actuator assembly is configured to bypass the third position.

In another embodiment, the clutch assembly can comprise: a posterior C-shaped sleeve; a conveyor plug operably coupled to the locking cam, whereby the cam further comprises a lock bit extending radially from the locking cam, and rotatably coupled to the posterior C-shaped sleeve; a bobbin having an anterior head portion coupled to the cylinder plug, a midsection axially spanning the locking cam, and a posterior head portion slidably and not rotatably coupled to the conveyor plug; an anterior C-shaped sleeve, defining a cylindrical volume, having an anterior bulkhead with a coaxial aperture, configured to slidably accommodate the shaft and not accommodate the limiting guide rails, the anterior bulkhead further comprising a ventral and a dorsal channel configured to accommodate and reversibly engage the guide rails disposed dorsally and ventrally on the shaft; a posterior drum having a posterior bulkhead defining a coaxial aperture therein, the drum configured to receive a posterior portion of an actuating spindle, with a portion of the actuating spindle extending through the aperture and abutting the anterior end of the bobbin, the posterior drum coupled to the conveyor plug; a locking cylinder rotatably coupled to the anterior C-shaped sleeve, having a posterior wall with a coaxial circular opening configured to accommodate a midsection of the actuating spindle and an anterior breaking washer, the washer biased in a posterior direction by a triggering biaser compressed between the breaking washer and the anterior bulkhead of the anterior C-shaped sleeve; a body column, defining body borehole therein extending transverse to longitudinal axis, the bore comprising a breaking pin, and a biaser configured to bias the breaking pin in the direction of the locking cylinder; and a bridging lever, disposed axially and protruding radially between the locking cylinder and the conveyor plug, the bridging lever configured to reversibly engage the conveyor plug, wherein upon removal of the posterior lock assembly, the locking cylinder is configured to translate in a posterior direction causing the anterior portion of the bobbin to engage the locking cam preventing rotational motion while exposing the borehole resulting in the breaking pin extending dorsally, preventing anterior motion of the locking pin.

In yet another embodiment, provided herein is a door, a window, a portal, a lid, a cover or an opening closure slab, comprising: a cylinder lock having an anterior end and posterior end along a longitudinal axis, the lock comprising: an anterior lock actuator assembly positioned axially anterior to a lock cam; the lock cam, adapted to lock and/or unlock the lock mechanism; a posterior lock actuator assembly comprising a knob operably coupled to a shaft positioned axially posterior to the lock cam; a clutch assembly, the clutch assembly being movable along the longitudinal axis between: a first position configured to transfer a rotational force path from the anterior lock actuator assembly to the lock cam; a second position configured to transfer a rotational force path from the posterior lock actuator assembly to the lock cam; and a third position in which the clutch is not movable along the axis, the third position triggered automatically upon removal of an anterior component of the cylinder lock, wherein the posterior lock actuator assembly is configured to bypass the third position.

These and other features of the latching mechanisms having selectably bypassed rotation arresting, described herein will become apparent from the following detailed description when read in conjunction with the drawings, which are exemplary, not limiting, and wherein like elements are numbered alike in several figures.

### BRIEF DESCRIPTION OF THE DRAWINGS

For a better understanding of the latching mechanisms with a selectably bypassed rotation arresting features described herein, with regard to the embodiments thereof, reference is made to the accompanying drawings, in which like numerals designate corresponding elements or sections throughout and in which:

FIG. 1A, shows an isometric view of an embodiment of the deadbolt cylinder lock without a key, with FIG. 1B illustrating the same lock with a key inserted;

FIG. 2, illustrates X-Y cross section A-A of FIG. 1B;

FIG. 3 shows an isometric view of the deadbolt cylinder lock after unauthorized removal of the posterior portion of the deadbolt cylinder lock;

FIG. 4, is a X-Y cross section illustration of the deadbolt cylinder lock illustrated in FIG. 3;

FIG. 5A, shows an isometric view of a first bypassing method of the triggered rotation arresting mechanism, with FIG. 5B showing front plan view thereof, while FIG. 5C illustrating a second bypassing method of the triggered rotation arresting mechanism, with FIG. 5D showing front plan view thereof; and

FIG. 6A, is a X-Y cross section illustration of the bypass method illustrated in FIG. 5A, and FIG. 6B—a X-Y cross section illustration of the bypass method illustrated in FIG. 5C.

### DETAILED DESCRIPTION

Provided herein are embodiments of a latching mechanisms having a triggered rotation arresting assembly therein, configured to inhibit rotation of the lock mechanism upon unauthorized removal of posterior portion of the latching mechanisms, while still allowing for selectably bypassing the rotation-arresting mechanism.

As indicated, special tools, such as plug pullers or plug extractors can be used to extract the cylinder plug from the cylinder housing, the plug pins being sheared off along a shear plane, followed by insertion of other tools emulating the pulled plug, the locking bit can then be manipulated to open the lock.

Furthermore, even in those cylinder locks that do provide a solution to this issue by introduction of spring-loaded mechanism that will arrest the rotation of the lock cam, once the rotation is arrested, there is no by-passing mechanism other than forced opening of the closure and removal of the damaged cylinder. Furthermore, when a deadlock is used anyone present ion the enclosure will be unable to open the enclosure from the inside.

To address these issue, provided herein is a cylinder lock having an anterior end and posterior end along a longitudinal axis, the lock comprising: an anterior lock actuator assembly positioned axially anterior to a lock cam; the lock cam, adapted to lock and/or unlock the lock mechanism; a posterior lock actuator assembly comprising a knob operably coupled to a shaft positioned axially posterior to the lock cam; a clutch assembly, the clutch assembly being movable along the longitudinal axis between: a first position configured to transfer a rotational force path (in other words, a torque force around a longitudinal axis defined by the keyway), from the anterior lock actuator assembly to the lock cam; a second position configured to transfer a rotational force path from the posterior lock actuator assembly to the lock cam; and a third position in which the clutch is not movable along the axis, the third position triggered automatically upon removal of an anterior component of the cylinder lock, wherein the posterior lock actuator assembly is configured to bypass the third position.

The anterior lock actuator assembly used in conjunction with the latching mechanisms having selectably bypassed rotation arresting described herein can comprise a barrel having a column extending ventrally from (in other words, below) the barrel; a cylinder plug rotatably coupled within the barrel, with a key way, or a passage extending along the longitudinal axis and rotatably coupled to the lock cam; a plurality of mutually aligned bores or drilled holes defined within the (posterior) column, extending transverse to the key way, each of the aligned bores comprising a locking pin, plug pin (which sometimes can have varying sizes and lengths) and a biaser configured to bias the plug pin in the direction of the passage.

As used herein, the terms “biaser”, “biasing element”, and the like refers to any device that provides a biasing force. Representative biasing elements include but are not limited to springs (e.g., elastomeric or metal springs, torsion springs, coil springs, leaf springs, tension springs, compression springs, extension springs, spiral springs, volute springs, flat springs, and the like), detents (e.g., spring-loaded detent balls, cones, wedges, cylinders, rubber cones, resilient elements and the like), pneumatic devices, hydraulic devices, magnets, and the like, and combinations thereof. Likewise, “biaser” as used herein refers to one or more members that applies an urging force between two elements.

In addition, the anterior lock actuator assembly used in conjunction with the latching mechanisms having selectably bypassed rotation arresting described herein can comprise a knob, a handle or other similarly situated shaft manipulating means coupled to an anterior end (the backend) of the shaft, hinge, or axle, wherein the shaft comprises: a borehole drilled in the shaft's posterior end thus defining a cylindrical depression with limiting guide rails protruding radially toward the shaft's posterior end (between about sixth to half the length of the shaft from the posterior end), the rails disposed dorsally (above) and ventrally (below); and a shaft biaser, the borehole configure to accommodate a portion of the clutch assembly and bias the shaft in an anterior direction (backwards, toward the interior of the enclosure) along the longitudinal axis of the cylinder lock.

In an embodiment, the clutch assembly, used in conjunction with the latching mechanisms (or in other words, the assembly used to engage and disengage the latching mechanisms), having selectably bypassed (e.g., from the knob side) rotation arresting mechanism described herein can be journaled within the cylinder housing and comprise: a posterior (or forward) C-shaped sleeve; a conveyor plug operably coupled to the locking cam and rotatably coupled (in other words, capable of rotating around the longitudinal axis in relation to the C-shaped sleeve) to the posterior C-shaped sleeve; a bobbin having an anterior head portion coupled to the cylinder plug and configured to transfer rotational force from the plug to the locking cam, a midsection axially spanning the width of the band forming the locking cam, and a posterior head portion slidably and not rotatably (in other words, it is incapable of rotating along the longitudinal axis of the rod forming the midsection), coupled to the conveyor plug; an anterior (in other words, rearwards) C-shaped sleeve, defining a cylindrical volume, having an anterior bulkhead (in other words floor) with a coaxial aperture (with the longitudinal axis of the conveyor plug), configured to slidably accommodate the shaft and not accommodate the limiting guide rails. The anterior bulkhead further comprises comprising complimentary ventral and dorsal channels configured to accommodate and reversibly engage the guide rails disposed dorsally and ventrally on the shaft of the anterior locking assembly. The clutch further comprising a posterior drum having a posterior bulkhead defining a coaxial aperture therein, the drum configured to receive a posterior portion of an actuating spindle (or firing pin), with a portion of the actuating spindle extending the trough the aperture and abutting the anterior end of the bobbin adapted to push the bobbin forward upon unauthorized removal of the cylinder plug. The posterior drum, which is configured to be biased away from the anterior head portion of the bobbin in an anterior direction (in other words, backwards) can be coupled to the conveyor plug; a locking cylinder disposed anterior to the conveyor plug, is adapted to be rotatably coupled to the anterior C-shaped sleeve, having a posterior wall with a coaxial circular opening configured to accommodate a midsection of the actuating spindle and an anterior breaking washer, the washer biased in a posterior direction by a triggering biaser compressed between the breaking washer and the anterior bulkhead of the anterior C-shaped sleeve; a body column, defining body borehole therein extending transverse to longitudinal axis, the bore comprising a breaking pin, and a biaser configured to bias the breaking pin in the direction of the locking cylinder; and a bridging lever, disposed axially and protruding radially between the locking cylinder and the conveyor plug, the bridging lever configured to reversibly engage the conveyor plug, wherein upon removal of the posterior lock assembly, the locking cylinder is configured to translate in a posterior direction causing the anterior portion of the bobbin to engage the locking cam preventing rotational motion while exposing the borehole resulting in the breaking pin extending dorsally, preventing anterior motion of the locking pin.

As used herein, the term “C-shaped” refers to any single structure that terminates in two prongs or legs, the majority of which extend in a same general direction. Transition between such prongs or legs may be curved, such as shown, or more of an acute right angle. In an embodiment, the anterior C-shape sleeve and the posterior C-shaped sleeve have a radial gap configured to limit the motion of the bridging lever and thus the rotation of the locking cam between a first locked position and a second unlocked position.

The term “coupled”, including its various forms such as “operably coupling”, “coupling” or “couplable”, refers to and comprises any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection.

In addition, the term “slidably” or “slidably coupled” refers to movement of one surface (for example the latching assembly) over a second surface (for example, the housing) while maintaining smooth continuous contact between the two surfaces. In another embodiment, the term “slidably coupled” means a state in which two or more components are coupled to one another such that at least one of the components (e.g., the latching assembly) at least slides with respect to another component (e.g., the housing). Likewise; the terms “slide,” “slid” or “sliding” are defined as moving, gliding or passing along or through a surface, although continuous contact at each point along the path is not necessarily required.

The term “engage” and various forms thereof, when used with reference to, for example, retention of the guide rails within the anterior bulkhead of the anterior C-shaped sleeve, refer to the application of any forces that tend to hold the rails and bulkhead together against inadvertent or undesired separating forces (e.g., such as may be introduced during attempts operate the anterior locking assembly—the deadbolt). It is to be understood, however, that engagement does not in all cases require an interlocking connection that is maintained against every conceivable type or magnitude of separating force.

In an embodiment, the bridging lever is configured to penetrate a portion of, and release or otherwise decouple the conveyor plug from the locking cylinder upon application of force in a posterior direction by the shaft, such as by pushing the knob shaft forward thus bypassing the triggered arresting.

The term “abut” or “abuts” should not be understood to strictly mean that the respective parts must be touching. Rather, “abuts” means that any remaining space between an abutting portion will not cancel or nullify the intended operation of the abutting components.

In another embodiment, provided herein is a deadbolt, a cylinder-housing, a lock cylinder (having a keyway), a posterior actuator formed with a hub connectable to a lock cylinder, the hub being journaled (in other words, an arrangement of parts where one part can rotate inside the other or slide in an arc along the other) in the cylinder-housing. Further, a strike can be coupled to the tube wherein a distance, in other words “a backset”, between an outer surface of a strike plate and a center of the hub (in other words, the aperture defined in the door to receive and install the locking cylinder) is defined by the notch in which the latch railing is fitted. The backset can vary from between about, for example, 60 mm (2.36 inch) to about 70 mm (2.75 inch). Other adjustment lengths are also contemplated and the range described is for example only. For example, a short adjustable backset can also be used, wherein the adjustable backset can vary from between about 44 mm (1.75 inch) and about 51 mm (2.0 inches).

A more complete understanding of the components, methods, and devices disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof, their relative size relationship and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function Likewise, cross sections are referred to on normal orthogonal coordinate system having XYZ axis, such that Y axis refers to front-to-back, X axis refers to side-to-side, and Z axis refers to up-and-down.

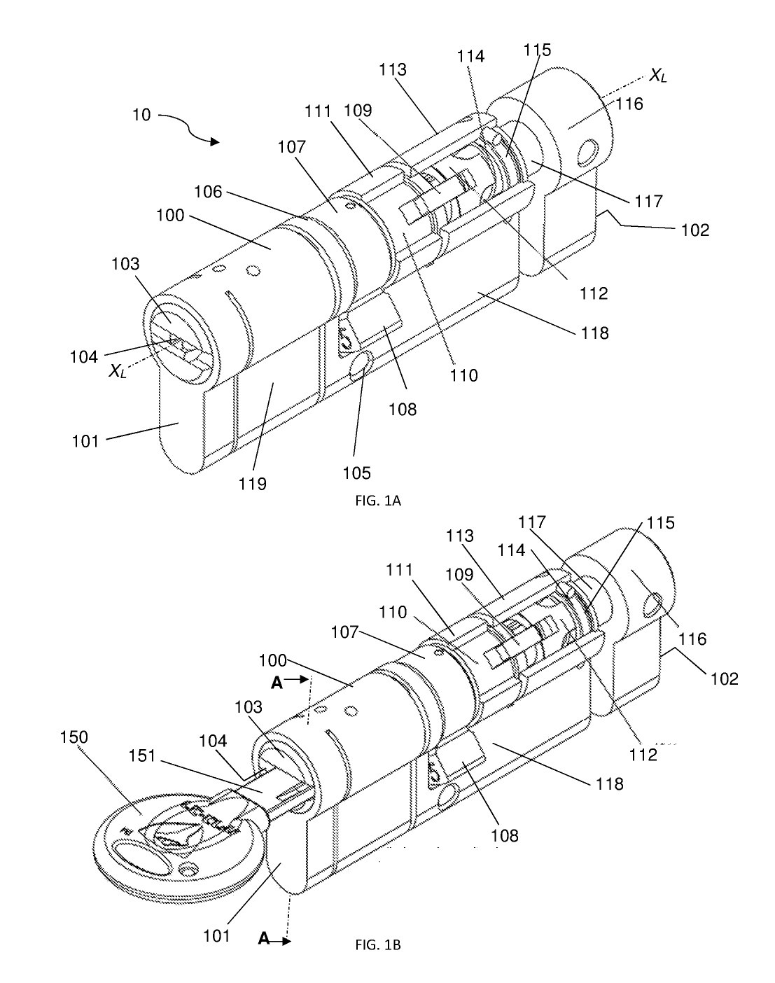

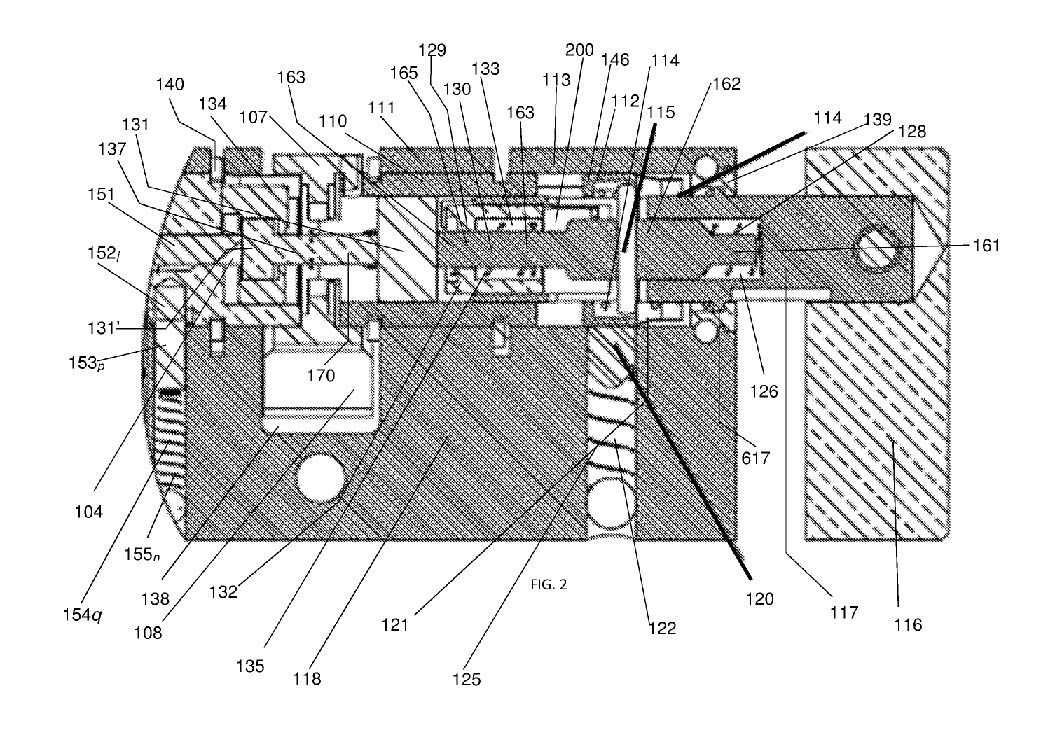

Turning now to FIG. 1A-FIG. 2, wherein FIG. 1A illustrates an isometric view of an embodiment of the deadbolt cylinder lock without a key, with FIG. 1B illustrating the same lock with a key inserted, with FIG. 2 illustrating a X-Y cross section of FIG. 1B. As illustrated, cylinder lock 10 has anterior end 101 (external) and posterior (internal) end 102 along longitudinal axis X_{L}, lock 10 comprising: anterior lock actuator assembly 100 positioned axially anterior to lock cam 107; lock cam 107, adapted to lock and/or unlock lock mechanism 10; posterior lock actuator assembly comprising knob 116 operably coupled to shaft 117 positioned axially posterior to lock cam 107; clutch assembly 200 (see e.g., FIG. 2), clutch assembly 200 being movable along longitudinal axis X_{L} between: a first position configured to transfer a rotational force path from anterior lock actuator assembly 100 to lock cam 107; a second position configured to transfer a rotational force path from the posterior lock actuator assembly to lock cam 107; and a third position in which clutch mechanism is not movable along axis X_{L}, the third position triggered automatically upon removal of an anterior component of cylinder lock 10, wherein anterior lock actuator assembly is configured to bypass the third position. FIG. 1A also shows alignment hole 105.

As illustrated in FIG. 1B and FIG. 2, the posterior lock actuator assembly comprises: posterior housing 100 having anterior column 119 extending ventrally from posterior housing 100; cylinder plug 103 rotatably coupled within posterior housing 100, with key way 104 extending along longitudinal axis X_{L} and rotatably coupled to lock cam 107; plurality of mutually aligned bores 155ₙ defined within anterior column 119, extending transverse to key way 104, each of aligned bores 155n comprising locking pin 152j, plug pin 153p and biaser 154q, configured to bias plug pin 153p in the direction of key way 104 passage. Conversely, and as illustrated in FIGS. 1B and 2 embodiments, the anterior lock actuator assembly comprises: knob 116 coupled to an anterior end of shaft 117 (see e.g., FIG. 1B), wherein shaft 117 comprises: shaft borehole 126 defined in shaft's 117 posterior end; limiting guide rails 617 defined radially toward the shaft's posterior end, the rails protruding from shaft 117 and disposed dorsally and ventrally; and shaft biaser 128, borehole 126 configured to accommodate a portion of clutch assembly 200 and bias shaft 117 in an anterior direction along longitudinal axis X_{L}.

As further illustrated in FIG. 1B and 2, also shown is key 150 with key blade 151 inserted in key way 104 passage. Assuming the proper key is inserted, locking pin 152ⱼ will form an interface with plug pin 153ₚ and cylinder plug 103, enabling rotation of cylinder plug 103. Rotation of key 150 will cause locking cam 107 and locking bit 108 extending radially therefrom to rotate and lock/unlock cylinder lock 10.

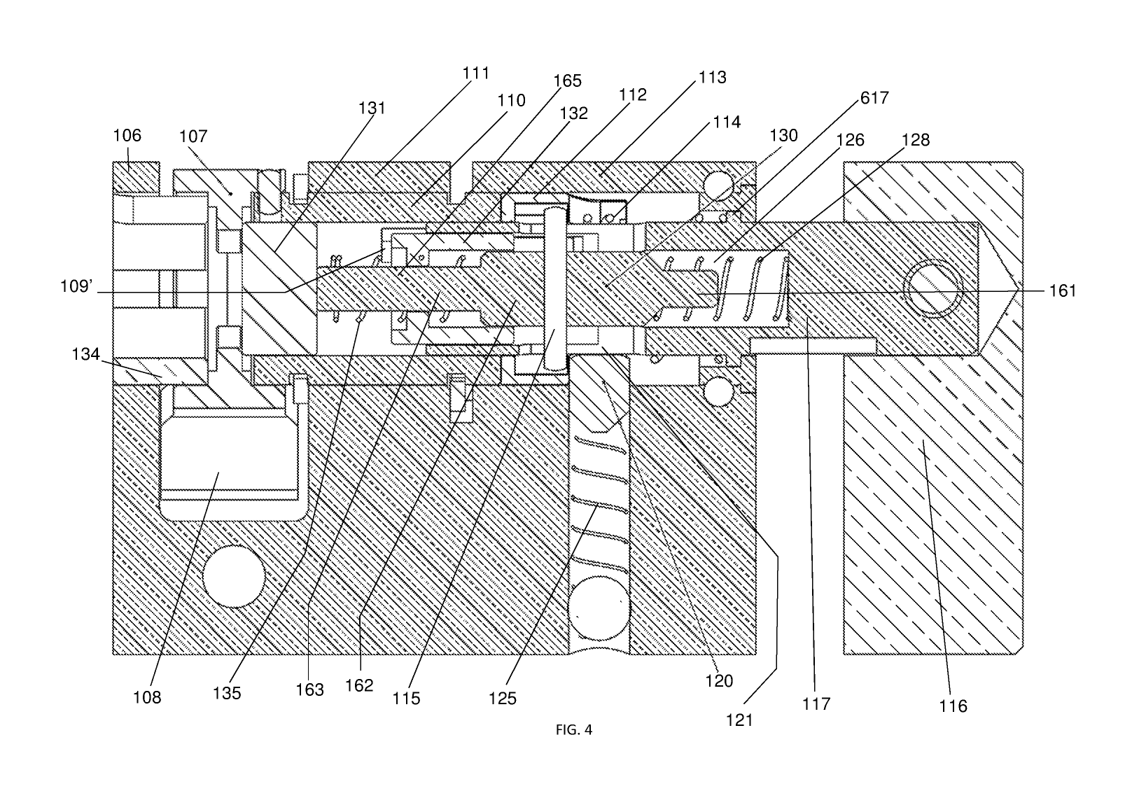

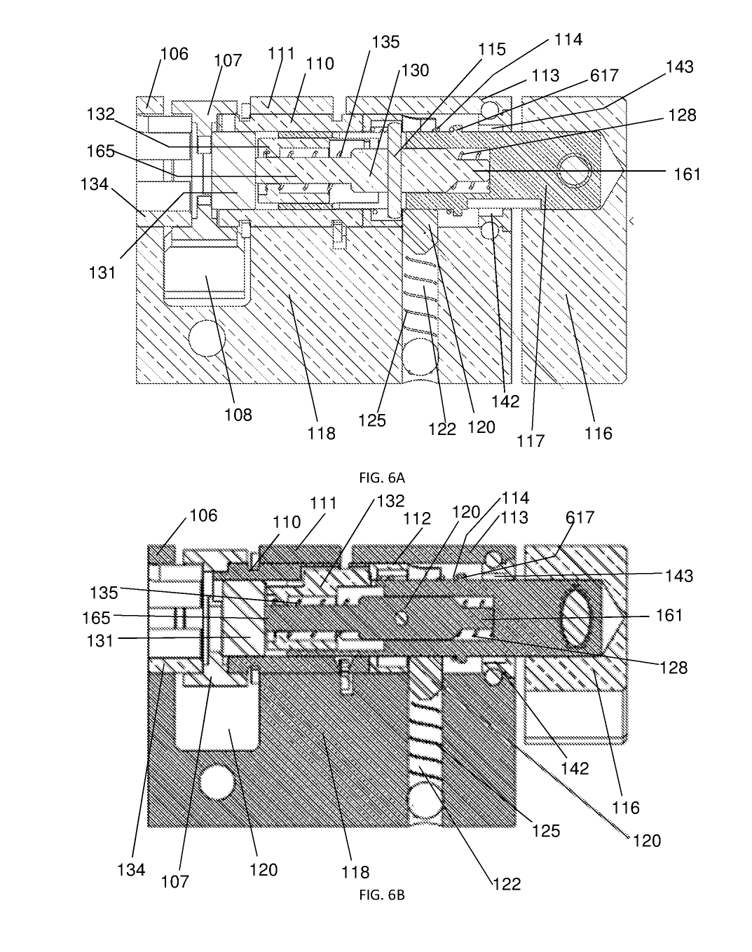

Turning now to FIG. 2, illustrating clutch assembly or mechanism journaled within posterior C-shaped sleeve 111 and anterior C-shaped sleeve 113. As illustrated, clutch assembly 200 comprises in an embodiment, posterior (or forward) C-shaped sleeve 111; a conveyor plug 110 operably coupled to locking cam 107 and rotatably coupled to posterior C-shaped sleeve 111. Also illustrated is bobbin 170 having anterior head portion 131 coupled to cylinder plug 103 and configured to transfer rotational force from cylinder plug 103 to locking cam 107, bobbin 170 midsection 137 axially spanning the width of the band forming locking cam 107, and posterior head portion 131′ slidably and not rotatably coupled to conveyor plug 110. Also shown in FIGS. 1A and 2, is anterior C-shaped sleeve 113, defining a cylindrical volume, having anterior bulkhead 139 (see FIG. 2), with a coaxial aperture (not shown), configured to slidably accommodate shaft 117 and not accommodate limiting guide rails 617. Anterior bulkhead 139 further comprises complimentary ventral and dorsal channels (142, 143 respectively, see e.g., FIG. 6A) configured to accommodate and reversibly engage guide rails 617 disposed dorsally and ventrally on shaft 117 of the anterior locking assembly. As illustrated, clutch 200 further comprising posterior drum 132 having posterior bulkhead 129 defining a coaxial aperture 165 therein, posterior drum 132, configured to receive posterior portion 163 of actuating spindle 130 (or firing pin), with a portion of actuating spindle 130 extending the trough aperture 165 and abutting anterior head portion 131 of bobbin 170, spindle 130 adapted to push bobbin 170 forward upon unauthorized removal of cylinder plug 103. Posterior drum 132, defining internal cylindrical cavity 133, which is configured to be biased away from anterior head portion 131 of bobbin 170 in an anterior direction is coupled to conveyor plug 110. As further illustrated, e.g., in FIG. 2, locking cylinder 112 disposed anterior to conveyor plug 110, is adapted to be rotatably coupled to anterior C-shaped sleeve 113, having posterior wall 146 with a coaxial circular opening configured to accommodate midsection 162 of actuating spindle 130 and anterior breaking washer 115, the breaking washer 115 biased in a posterior direction by triggering biaser 114 (see e.g., FIG. 4), compressed between breaking washer 115 and anterior bulkhead 139 of anterior C-shaped sleeve 113. Body column 118 is illustrated as defining body borehole 122 therein extending transverse to longitudinal axis X_{L}, the body borehole 122 containing breaking pin 120, and body biaser 125 configured to bias breaking pin 120 in the direction of locking cylinder 112. As illustrated in FIG. 1B, also shown is bridging lever 109, disposed axially (in parallel with longitudinal axis X_{L}) and protruding radially between, and selectably coupling locking cylinder 112 and conveyor plug 110, whereby bridging lever 109 can be adapted to reversibly and selectably (in other words, without affecting the operation of components or elements not coupled to bridging lever 109) engage conveyor plug 110, wherein upon removal of the posterior lock assembly, locking cylinder 112 is configured to translate in a posterior direction causing the anterior head portion 131 of bobbin 170 to engage locking cam 107, while exposing body borehole 122 resulting in breaking pin 120 extending dorsally into the pit 121 defined locking cylinder 112 configured to receive and engage breaking pin 120, preventing anterior motion of washer 115 and rotation of locking cylinder 112, thus arresting the unlocking of cylinder lock 10. As further illustrated in FIG. 2, posterior drum 132 is biased away from anterior head portion 131 of bobbin 170 in an anterior direction, via, for example biaser 135 disposed within internal cavity 133.

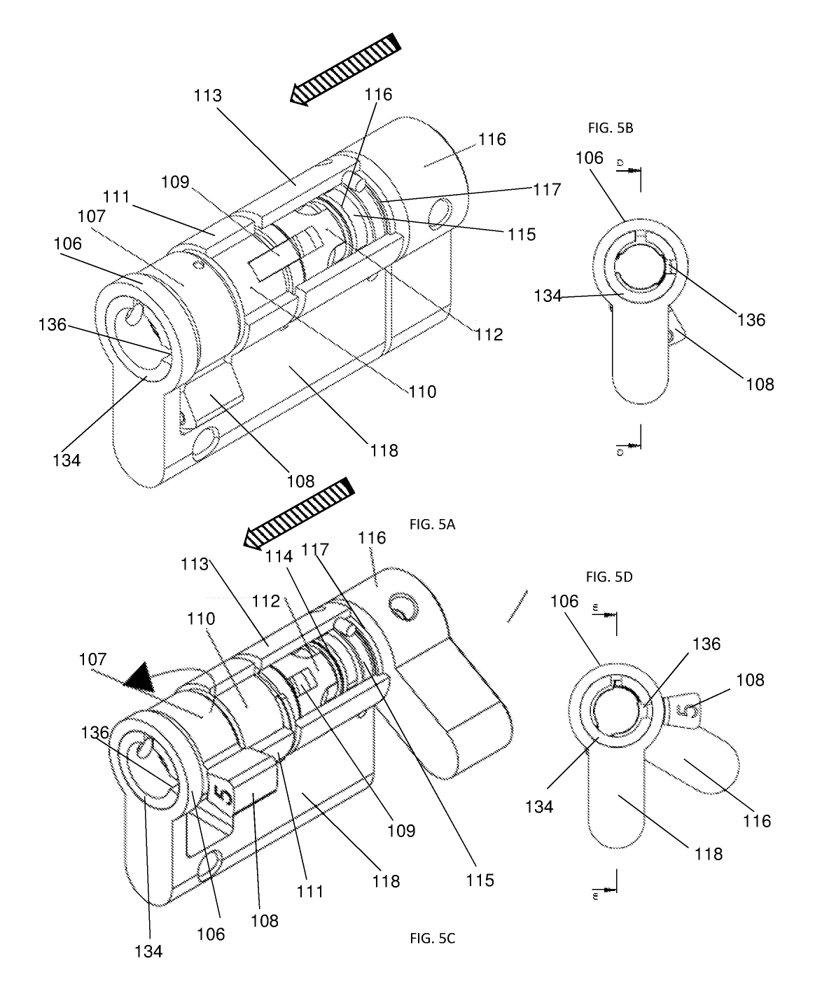

As shown in FIG. 2, locking cam 107 further comprises locking bit 108 extending radially from the locking cam, configured to rotate within window 138 defined in body column 118. FIG. 2, also shows joint ring 140, effectively creating a notch resulting in a shear plane of cylinder lock 10 housing 100 at a predetermined position along cylinder 10 (see e.g., shear plane 106, FIGS. 1A, 3, 5A). Furthermore, as illustrated in FIGS. 1A, 1B, (as well as FIGS. 5B and 5D) anterior C-shape sleeve 113 and posterior C-shaped sleeve 111 have a radial gap configured to limit the motion of bridging lever 109 and thus the rotation of locking cam 107 between a first locked position and a second unlocked position.

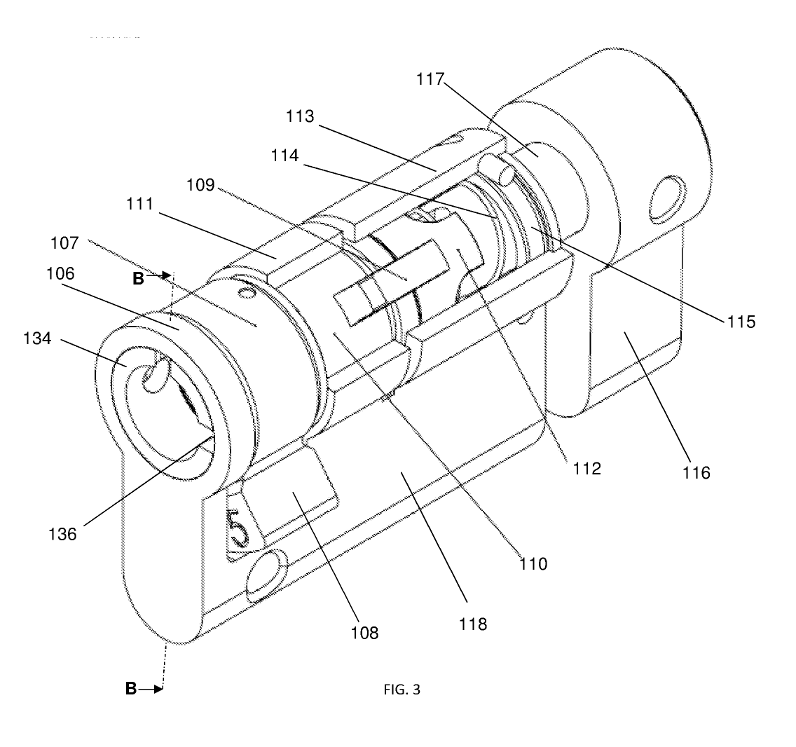

Turning now to FIGS. 3, and 4, illustrating in FIG. 3 an isometric view of the deadbolt cylinder lock after unauthorized removal of the posterior portion of the deadbolt cylinder lock and in FIG. 4, a X-Y cross section illustration of the deadbolt cylinder lock illustrated in FIG. 3. Following an attack, whereby cylinder plug 103 is either extracted, or the entire housing 100 is removed, (for example, by shearing cylinder housing 100 along the shear plane formed by joint ring 140, locking cylinder 112 will be biased forward now that posterior head portion 131′ and midsection 137 of bobbin 170 have been sheared off, resulting in the removal of a counterforce on triggering biaser 114. Locking cylinder 112 would then translate forward causing the anterior head portion 131 of bobbin 170 to engage locking cam 107, while exposing body borehole 122 resulting in breaking pin 120 extending dorsally into the pit 121 defined locking cylinder 112 configured to receive and engage breaking pin 120, preventing anterior motion of washer 115 as well as rotation of locking cylinder 112, thus arresting the unlocking of deadbolt cylinder lock 10. Shearing will expose internal ferrule 134 (showing gap 136).

Turning to FIG. 5, illustrating in 5A an isometric view of a first bypassing method of the triggered rotation arresting mechanism, with FIG. 5B showing front plan view thereof, while FIG. 5C illustrating a second bypassing method of the triggered rotation arresting mechanism, with FIG. 5D showing front plan view thereof. As illustrated in FIGS. 5A and 5C, bridging lever 109 is configured to engage and release or decouple conveyor plug 110 from locking cylinder 112 upon application of force in a posterior direction by shaft 117, thus causing guide rails 617 to disengage from ventral and dorsal channels 142, 143 (respectively) as well. With respect to FIG. 5A, 5B, in an embodiment, using the deadbolt cylinder lock or latch described herein, it is possible to bypass the triggered rotation arresting mechanism. As illustrated in FIGS. 5A, 5B, and 6A, simultaneously pushing shaft 117 and rotating knob 116, will cause bridging lever 109 by pushing bridging lever 109 member 109′ (see e.g., FIG. 4) to decouple locking cylinder 112 from conveyor plug 110, coupled to locking cam 107, thus enabling rotation of locking cam 107 and opening deadbolt cylinder lock 10 using the anterior locking assembly (or interchangeably—mechanism).

Another bypass example is illustrated in FIGS. 5C, 5D, and 6B. As illustrated, rotation of locking cam 107 forcefully, such that locking bit 108 is parallel with key way 104 passage, will result in shearing off bridging lever 109, thus decoupling locking cylinder 112 from conveyor plug 110, coupled to locking cam 107, and again, enabling rotation of locking cam 107 and opening deadbolt cylinder lock 10 using the anterior locking assembly.

The term “about”, when used in the description of the technology and/or claims means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such and may include the end points of any range provided including, for example ±25%, or ±20%, specifically, ±15%, or ±10%, more specifically, ±5% of the indicated value of the disclosed amounts, sizes, formulations, parameters, and other quantities and characteristics.

All ranges disclosed herein are inclusive of the endpoints, and the endpoints are independently combinable with each other. “Combination” is inclusive of blends, mixtures, alloys, reaction products, and the like. Furthermore, the terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the device(s) includes one or more device). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “rotatably” coupled means that two components are attached to each other, perhaps via one or more other components, such that one or both of the two components can rotate. Additionally, or alternatively, the term “rotatably coupled” refers to a situation where one element is coupled to another element in a fixed spatial relation, but is free to rotate with respect to the other element. In other words, no substantial lateral movements of the two elements take place, while relative rotation between the two elements is possible. In yet other words, the term “rotatably coupled” refers to a situation where the rotation of the one element does not necessarily result in a rotation of the other element and vice versa. The one element may be supported with respect to or mounted to the other element in a way that permits rotation, such as via a ball bearing, hinges and the like. Similarly, the term “slidably coupled” is used in its broadest sense to refer to elements which are coupled in a way that permits one element to slide or translate with respect to another element.

Accordingly and in an embodiment, provided herein is a cylinder lock having an anterior end and posterior end along a longitudinal axis, the lock comprising: an anterior lock actuator assembly positioned axially anterior to a lock cam; the lock cam, adapted to lock and/or unlock the lock mechanism; a posterior lock actuator assembly comprising a knob operably coupled to a shaft positioned axially posterior to the lock cam; a clutch assembly, the clutch assembly being movable along the longitudinal axis between: a first position configured to transfer a rotational force path from the anterior lock actuator assembly to the lock cam; a second position configured to transfer a rotational force path from the posterior lock actuator assembly to the lock cam; and a third position in which the clutch is not movable along the axis, the third position triggered automatically upon removal of an anterior component of the cylinder lock, wherein the anterior lock actuator assembly is configured to bypass the third position, wherein, (i) the posterior lock actuator assembly comprises: a barrel having a column extending ventrally from the barrel; a cylinder plug rotatably coupled within the barrel, with a key way extending along the longitudinal axis and rotatably coupled to the lock cam; a plurality of mutually aligned bores defined within the column, extending transverse to the key way, each of the aligned bores comprising a locking pin, plug pin and a biaser configured to bias the plug pin in the direction of the passage, (ii) the anterior lock actuator assembly comprises: the knob coupled to an anterior end of the shaft and wherein the shaft comprises: a borehole defined in the shaft's posterior end; a limiting guide rails defined radially toward the shaft's posterior end, the rails disposed dorsally and ventrally; and a shaft biaser the borehole configure to accommodate a portion of the clutch assembly and bias the shaft in an anterior direction along the longitudinal axis, wherein (iii) the clutch assembly comprises: a posterior C-shaped sleeve; a conveyor plug operably coupled to the locking cam and rotatably coupled to the posterior C-shaped sleeve a bobbin having an anterior head portion coupled to the cylinder plug, a midsection axially spanning the locking cam, and a posterior head portion slidably and not rotatably coupled to the conveyor plug; an anterior C-shaped sleeve, defining a cylindrical volume, having an anterior bulkhead with a coaxial aperture, configured to slidably accommodate the shaft and not accommodate the limiting guide rails, the anterior bulkhead further comprising a ventral and a dorsal channel configured to accommodate and reversibly engage the guide rails disposed dorsally and ventrally on the shaft; a posterior drum having a posterior bulkhead defining a coaxial aperture therein, the drum configured to receive a posterior portion of an actuating spindle, with a portion of the actuating spindle extending through the aperture and abutting the anterior end of the bobbin, the posterior drum coupled to the conveyor plug; a locking cylinder rotatably coupled to the anterior C-shaped sleeve, having a posterior wall with a coaxial circular opening configured to accommodate a midsection of the actuating spindle and an anterior breaking washer, the washer biased in a posterior direction by a triggering biaser compressed between the breaking washer and the anterior bulkhead of the anterior C-shaped sleeve; a body column, defining body borehole therein extending transverse to longitudinal axis, the bore comprising a breaking pin, and a biaser configured to bias the breaking pin in the direction of the locking cylinder; and a bridging lever, disposed axially and protruding radially between the locking cylinder and the conveyor plug, the bridging lever configured to reversibly engage the conveyor plug, wherein upon removal of the posterior lock assembly, the locking cylinder is configured to translate in a posterior direction causing the anterior portion of the bobbin to engage the locking cam while exposing the borehole resulting in the breaking pin extending dorsally into a pit defined in the locking cylinder configured to receive and engage the breaking pin, preventing rotational and anterior motion of the locking cylinder, (iv) wherein the locking cam further comprises a lock bit extending radially from the locking cam, wherein (v) the anterior C-shape sleeve and the posterior C-shaped sleeve have a radial gap configured to limit the motion of the bridging lever and thus the rotation of the locking cam between a first locked position and a second unlocked position, (vi) the posterior drum is biased away from the anterior head portion of the bobbin in an anterior direction, and wherein (vii) the bridging lever is configured to release the conveyor plug upon application of force in a posterior direction by the shaft.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. A cylinder lock having an anterior end and posterior end along a longitudinal axis, the lock comprising:
a. an anterior lock actuator assembly positioned axially anterior to a lock cam;
b. the lock cam, adapted to lock and/or unlock the lock mechanism;
c. a posterior lock actuator assembly comprising a knob operably coupled to a shaft positioned axially posterior to the lock cam;
d. a clutch assembly, the clutch assembly being movable along the longitudinal axis between:
i. a first position configured to transfer a rotational force path from the anterior lock actuator assembly to the lock cam;
ii. a second position configured to transfer a rotational force path from the posterior lock actuator assembly to the lock cam; and
iii. a third position in which the clutch is not movable along the axis, the third position triggered automatically upon removal of an anterior component of the cylinder lock,
wherein the anterior lock actuator assembly is configured to bypass the third position.

2. The lock of claim 1, wherein the posterior lock actuator assembly comprises:
a. a barrel having a column extending ventrally from the barrel;
b. a cylinder plug rotatably coupled within the barrel, with a key way extending along the longitudinal axis and rotatably coupled to the lock cam;
c. a plurality of mutually aligned bores defined within the column, extending transverse to the key way, each of the aligned bores comprising a locking pin, plug pin and a biaser configured to bias the plug pin in the direction of the passage.

3. The lock of claim 2, or wherein the anterior lock actuator assembly comprises: the knob coupled to an anterior end of the shaft wherein the shaft comprises:
a. a borehole defined in the shaft's posterior end;
b. a limiting guide rails defined radially toward the shaft's posterior end, the rails disposed dorsally and ventrally; and
c. a shaft biaser
the borehole configure to accommodate a portion of the clutch assembly and bias the shaft in an anterior direction along the longitudinal axis.

4. The lock of claim 1, wherein the clutch assembly comprises:
a. a posterior C-shaped sleeve;
b. a conveyor plug operably coupled to the locking cam and rotatably coupled to the posterior C-shaped sleeve
c. a bobbin having an anterior head portion coupled to the cylinder plug, a midsection axially spanning the locking cam, and a posterior head portion slidably and not rotatably coupled to the conveyor plug;
d. an anterior C-shaped sleeve, defining a cylindrical volume, having an anterior bulkhead with a coaxial aperture, configured to slidably accommodate the shaft and not accommodate the limiting guide rails, the anterior bulkhead further comprising a ventral and a dorsal channel configured to accommodate and reversibly engage the guide rails disposed dorsally and ventrally on the shaft;
e. a posterior drum having a posterior bulkhead defining a coaxial aperture therein, the drum configured to receive a posterior portion of an actuating spindle, with a portion of the actuating spindle extending through the aperture and abutting the anterior end of the bobbin, the posterior drum coupled to the conveyor plug;
f. a locking cylinder rotatably coupled to the anterior C-shaped sleeve, having a posterior wall with a coaxial circular opening configured to accommodate a midsection of the actuating spindle and an anterior breaking washer, the washer biased in a posterior direction by a triggering biaser compressed between the breaking washer and the anterior bulkhead of the anterior C-shaped sleeve;
g. a body column, defining body borehole therein extending transverse to longitudinal axis, the bore comprising a breaking pin, and a biaser configured to bias the breaking pin in the direction of the locking cylinder; and
h. a bridging lever, disposed axially and protruding radially between the locking cylinder and the conveyor plug, the bridging lever configured to reversibly engage the conveyor plug,
wherein upon removal of the posterior lock assembly, the locking cylinder is configured to translate in a posterior direction causing the anterior portion of the bobbin to engage the locking cam while exposing the borehole resulting in the breaking pin extending dorsally into a pit defined in the locking cylinder configured to receive and engage the breaking pin, preventing rotational and anterior motion of the locking cylinder.

5. The lock of claim 4, wherein the locking cam further comprises a lock bit extending radially from the locking cam.

6. The lock of claim 5, wherein the anterior C-shape sleeve and the posterior C-shaped sleeve have a radial gap configured to limit the motion of the bridging lever and thus the rotation of the locking cam between a first locked position and a second unlocked position.

7. The lock of claim 5, wherein the posterior drum is biased away from the anterior head portion of the bobbin in an anterior direction.

8. The lock of claim 4, wherein the bridging lever is configured to release the conveyor plug upon application of force in a posterior direction by the shaft.
